(19) United States
(12) Patent Application Publication
(10) Pub. No.: US 2014/0043803 A1
(43) Pub. Date: Feb. 13, 2014

(54) LIGHT-EMITTING MODULE AND LIGHTING APPARATUS

(71) Applicant: TOSHIBA LIGHTING & TECHNOLOGY CORPORATION, Kanagawa (JP)

(72) Inventors: Seiko Kawashima, Kanagawa (JP); Takahito Kashiwagi, Kanagawa (JP); Yoshiko Takahashi, Kanagawa (JP); Kazuo Shimokawa, Kanagawa (JP); Masahiro Fujita, Kanagawa (JP); Tsuyoshi Oyaizu, Kanagawa (JP)

(73) Assignee: Toshiba Lighting & Technology Corporation, Kanagawa (JP)

(21) Appl. No.: 13/689,036

(22) Filed: Nov. 29, 2012

(30) Foreign Application Priority Data
Aug. 8, 2012 (JP) 2012-176364

(51) Int. Cl. F21V 21/00

(52) U.S. Cl. CPC F21V 21/00
USPC 362/231

(57) ABSTRACT

A light-emitting module according to an embodiment includes a substrate. The light-emitting module according to the embodiment includes a light-emitting elements (for example, red LEDs and blue LEDs) of different types provided on the substrate, the light emitting elements of each such type configured to emit light having a different wavelength. The light-emitting module according to the embodiment includes a first transparent member provided on the substrate and configured to partition the light-emitting elements on the substrate according to their type and allow light emitted from the light-emitting elements to be transmitted at a predetermined transmissivity.

### CROSS-REFERENCE TO RELATED APPLICATION

This application is based upon and claims the benefit of priority from the prior Japanese Patent Application No. 2012-176364, filed on Aug. 8, 2012, the entire contents of which are incorporated herein by reference.

### FIELD

Embodiments described herein relates generally to a light-emitting module and a lighting apparatus.

### BACKGROUND

In recent years, a type having a plurality of LED (light-emitting diode) chips mounted on a substrate is now in practical use as an LED module.

Examples of the light-emitting module include a type which is used as a light source for a LED lamp, which is an intensively-mounted-type formed by forming a white stopper member on the substrate on which a plurality of the LED chips are intensively mounted and flowing a phosphor resin in a space formed by the stopper member.

However, there is a case where a range irradiated with light emitted from the LED chips by the stopper member is reduced and an angular color difference is increased. In this case, there is a problem that the quality of light output from an LED lamp is poor.

It is an object of exemplary embodiments to provide a light-emitting module and a lighting apparatus capable of outputting relatively homogeneous and good quality light.

### DESCRIPTION OF THE DRAWINGS

FIG. 1 illustrates a vertical cross-sectional view of a lighting apparatus having a light-emitting module according to a first embodiment mounted thereon;

FIG. 2 illustrates a top view of the light-emitting module according to the first embodiment;

FIG. 3 illustrates a lateral cross-sectional view of a lighting apparatus having the light-emitting module according to the first embodiment mounted thereon;

FIG. 4 illustrates electric wire of the light-emitting module according to the first embodiment;

FIG. 5 illustrates a top view of the light-emitting module according to a second embodiment;

FIG. 6 illustrates an example of a result of experiment; and

FIG. 7 illustrates an example of the result of experiment.

### DETAILED DESCRIPTION

Referring now to the drawings, the light-emitting module and a lighting apparatus according to embodiments will be described. In the respective embodiments, configurations having the same function are designated by the same reference numerals and overlapped description will be omitted. The light-emitting module and the lighting apparatus described in the embodiments below are examples only, and do not limit the invention. The embodiments described below may be combined as needed within the range providing no contradiction.

In a first embodiment and a second embodiment described below, the light-emitting module includes a substrate. The light-emitting module includes light-emitting elements of different types provided on the substrate, the light-emitting elements of each such type configured to emit light having a different wavelength. The light-emitting module includes a first transparent member configured to partition the light-emitting elements on the substrate according to their type and allow light emitted from the light-emitting elements to be transmitted at a predetermined transmissivity. According to light-emitting modules of the first embodiment and the second embodiment, light emitted from the light-emitting elements is transmitted through the first transparent member at the predetermined transmissivity in a state in which the light-emitted elements are partitioned by type. Accordingly, a range irradiated with the light emitted from light emitting elements of different types is widened. Therefore, an angle-to-angle brightness difference and an angular color difference are inhibited in the light emitted from the light-emitting modules of the first embodiment and the second embodiment. Therefore, according to the light-emitting modules of the first embodiment and the second embodiment, output of relatively homogeneous and good quality light is achieved.

In the first embodiment and the second embodiment given below, a plurality of the light-emitting elements include light-emitting elements of a first type configured to emit light having a first wavelength and light-emitting elements of a second type configured to emit light having a second wavelength.

In the first embodiment and the second embodiment given below, the transmissivity of the first transparent member falls within a range from 80% to 95% inclusive.

In the first embodiment and the second embodiment given below, the transmissivity of the first transparent member is 100%.

In the first embodiment and the second embodiment given below, the reflection ratio of the first transparent member falls within a range from 10% to 15% inclusive.

In the first embodiment and the second embodiment given below, the first transparent member is formed of a material including a silicone resin.

In the first embodiment and the second embodiment given below, the light-emitting elements of the first type have a first thermal characteristic such that luminescence of the light-emitting elements of the first type is lowered with an increase in temperature of the light-emitting elements of the first type. The light-emitting elements of the second type have a second thermal characteristic such that luminescence of the light-emitting elements of second type is lowered with an increase in temperature of the light-emitting element of the second type by a larger amount than the luminescence of the light-emitting elements of the first type is lowered.

In the first embodiment and the second embodiment given below, the light-emitting elements of the second type are arranged, for example, in a ring pattern on the substrate, and the light-emitting elements of the first type are arranged at the center of the ring pattern on the substrate. In this manner, by arranging the second type light-emitting elements which are susceptible to heat into the ring pattern which allows heat from being released easier than the center of the ring pattern, lowering of the amount of luminescence of the second type light-emitting elements inferior in thermal characteristic may be inhibited.

In the first embodiment and the second embodiment given below, the ring pattern includes a circular ring pattern, a rectangular pattern, and a diamond pattern.

In the first embodiment and the second embodiment given below, a minimum distance between the light-emitting elements of the first type and the light-emitting elements of the second type is longer than a length in a direction that is perpendicular to the surface of the substrate. Heat produced by the first type light-emitting elements and the second type light-emitting elements through light emission is conducted on the substrate more easily in the horizontal direction than in the perpendicular direction. Therefore, the heat produced by the first type light-emitting elements is conducted to the second type light-emitting elements in the horizontal direction of the substrate, and light-emitting efficiency of the second type light-emitting elements is further worsened. However, by setting the distance between the first type light-emitting elements and the second type light-emitting elements to be longer than the thickness of the substrate in the perpendicular direction, conduction of heat produced by the first type light-emitting elements to the second type light-emitting elements in the horizontal direction of the substrate is inhibited. Therefore, worsening of the light-emitting efficiency of the second type light-emitting elements is inhibited.

Lighting apparatuses of the first embodiment and the second embodiment give below include the light-emitting module. According to the lighting apparatuses of first embodiment and the second embodiment, light emitted from the light-emitting elements is transmitted through the first transparent member at a predetermined transmissivity in a state in which the light-emitting elements are partitioned by type. Therefore, an angle-to-angle brightness difference and an angular color difference are inhibited in the light output from the lighting apparatuses of the first embodiment and the second embodiment. Therefore, according to the lighting apparatuses of the first embodiment and the second embodiment, output of relatively homogeneous and good quality light is achieved.

The light-emitting module according to the second embodiment described below includes a second transparent member provided an outer periphery of the light-emitting elements of different types and configured to allow light emitted from the light-emitting elements at a predetermined transmissivity. According to the light-emitting module of the second embodiment, the light from the light-emitting elements is transmitted through the second transparent member provided on the outside at the predetermined transmissivity. Accordingly, the range irradiated with the light emitted from the light emitting elements is widened. Therefore, color separation and an angular color difference of the light output from the light-emitting module of the second embodiment is inhibited. Therefore, according to the light-emitting module of the second embodiment, output of relatively homogeneous and good quality light is achieved.

In the second embodiment given below, the transmissivity of the second transparent member falls within a range from 80% to 95% inclusive.

In the second embodiment given below, the reflection ratio of the second transparent member falls within a range from 10% to 15% inclusive.

In the second embodiment given below, the second transparent member is formed of the material including the silicone resin.

In the first embodiment and the second embodiment described below, an LED chip may be exemplified as a semiconductor light-emitting element. However, the embodiments are not limited thereto and, for example, a semiconductor laser, an EL (Electro Luminescence) element may be used as well. When using the LED chips as the light emitting elements, the color of emitted light from the LED chips may be any of red, green, and blue. The LED chips having different emission colors may be combined.

In the embodiments given below, the lighting apparatus is described as having a krypton bulb shape. However, the shape of the lighting apparatus is not limited thereto, and may be of a general bulb shape and a bombshell shape.

### First Embodiment

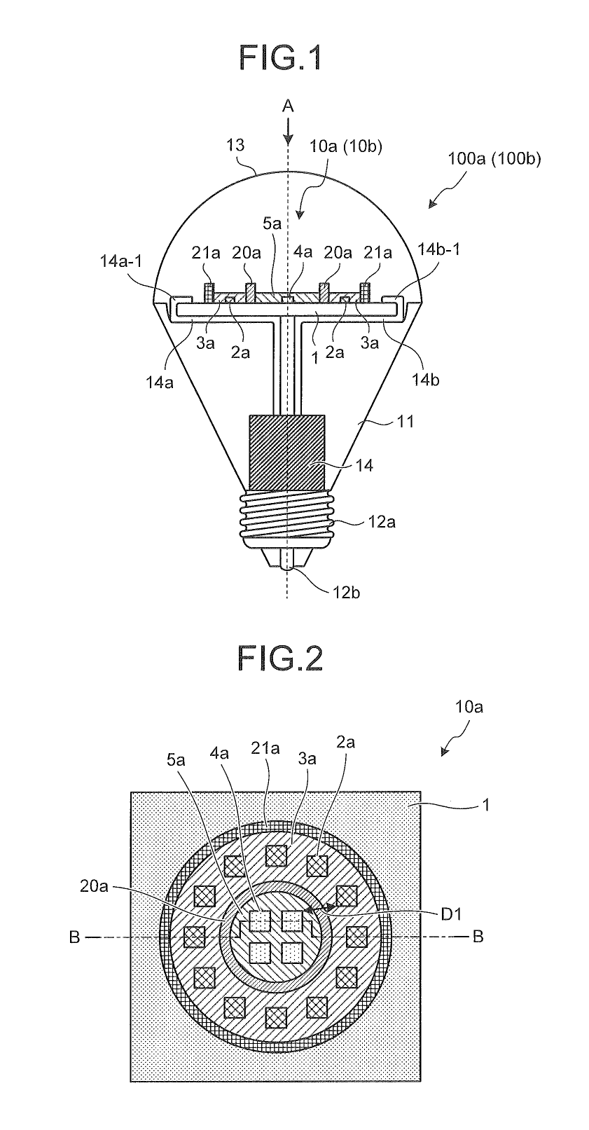

FIG. 1 illustrates a vertical cross-sectional view of a lighting apparatus having a light-emitting module according to the first embodiment mounted thereon. As illustrated in FIG. 1, a lighting apparatus 100a according to the first embodiment includes a light-emitting module 10a. Also, the lighting apparatus 100a includes a main body 11, a cap member 12a, an eyelet portion 12b, a cover 13, a control unit 14, an electric wire 14a, an electrode bonding portion 14a-1, an electric wire 14b, and an electrode bonding portion 14b-1.

The light-emitting module 10a is arranged on an upper surface of the main body 11 in the perpendicular direction. The light-emitting module 10a includes a substrate 1. The substrate 1 is formed of ceramics having low-thermal conductivity, for example, alumina. The thermal conductivity of the substrate 1 is, for example, 33 [W/m·K] under 300[K] atmosphere.

When the substrate 1 is formed of ceramics, mechanical strength and dimensional accuracy are also high. Therefore, a contribution to improvement of yield when the light-emitting module 10a is mass-produced, a reduction of manufacturing cost of the light-emitting module 10a, and an elongation of lifetime of the light-emitting module 10a is made. Also, the ceramics improves the light-emitting efficiency of the LED module since the reflection ratio of visible light is high.

The substrate 1 is not limited to alumina. For example, the substrate 1 may be formed of silicon nitride, silicon oxide, or the like. The thermal conductivity of the substrate 1 is preferably 20 to 70 [W/m·K]. When the thermal conductivity of the substrate 1 is 20 to 70 [W/m·K], a manufacturing cost, a reflection ratio, and thermal effects among the light-emitting elements mounted on the substrate 1 may be inhibited. Also, the substrate 1 formed of ceramics having suitable thermal conductivity is capable of inhibiting the thermal effects among the light-emitting elements mounted on the substrate 1 in comparison with those having a high thermal conductivity. Therefore, the substrate 1 formed of ceramics having a suitable thermal conductivity allows a separation distance among the light-emitting elements mounted on the substrate 1 to be reduced, so that further downsizing is enabled. The substrate 1 may be formed of nitride of aluminum such as aluminum nitride. In this case, the thermal conductivity of the substrate 1 is smaller than 225 [W/m·K] which is a thermal conductivity of aluminum having approximately 99.5 mass %, for example, under 300[K] atmosphere.

The light-emitting module 10a includes red LEDs 2a arranged on a circumference of an upper surface of the substrate 1 in the perpendicular direction. The light-emitting module 10a also includes blue LEDs 4a arranged near the center of the upper surface of the substrate 1 in the perpendicular direction. The amount of luminescence of the red LEDs 2a is further decreased with increase in temperature of the light-emitting elements in comparison with the blue LEDs 4a. In other words, the red LEDs 2a have an inferior heat characteristic in comparison with the blue LEDs 4a in that the amount of luminescence is further decreased with increase in temperature of the light-emitting elements. According to the first embodiment, since the substrate 1 is formed of ceramics having low thermal conductivity, heat produced by the blue LEDs 4a is inhibited from being conducted to the red LEDs 2a via the substrate 1, and the light-emitting efficiency of the red LEDs 2a is inhibited from being worsened.

The red LEDs 2a have a peak of wavelength of light emitted therefrom of, for example, 635 nm, and the blue LEDs 4a have a peak of wavelength of light emitted therefrom of, for example, 450 nm.

In FIG. 1, the blue LEDs 4a and the red LEDs 2a are illustrated with decreased numbers. In other words, as the first LED group, a plurality of the red LEDs 2a are arranged on the circumference of the upper surface of the substrate 1 in the perpendicular direction. As the second LED group, a plurality of blue LEDs 4a are arranged near the center of the upper surface of the substrate 1 in the perpendicular direction.

The first LED group including a plurality of red LED 2a is covered from above with a sealing portion 3a formed by pouring various types of resin into a space defined by a first transparent member 20a and a member 21a, which are both stopper members, and the substrate 1, and causing the same to be cured therein. The sealing member 3a has a substantially semicircular or substantially trapezoidal shape on an upper surface of the substrate 1 in the perpendicular direction, and is formed into a circular ring shape so as to cover the plurality of red LEDs 2a. Also, the second LED group including the plurality of the blue LEDs 4a is covered with a sealing portion 5a from above together with a depression defined by an inner surface of the formed by the first transparent member 20a and the substrate 1.

The first transparent member 20a is formed of a material including silicone resin. The first transparent member 20a is provided so as to partition between the first LED group including a plurality of the red LEDs 2a and the second LED group including a plurality of the blue LEDs 4a on the substrate 1 by the type of wavelength of light emitted. The first transparent member 20a allows light emitted from the blue LEDs 4a and the red LEDs 2a to be transmitted at a predetermined transmissivity. For example, assuming that the transmissivity of the first transparent member 20a is 100%, the light emitted from the blue LEDs 4a and the red LEDs 2a and irradiating the first transparent member 20a are wholly transmitted through the first transparent member 20a. This causes light interference and light of bad quality is output from the lighting apparatus 100a. In order to disturb the incidence of such a situation, the transmissivity of the first transparent member 20a is, for example, 86%. The value of the transmissivity of the first transparent member 20a is not limited thereto. For example, the transmissivity of the first transparent member 20a may by any values in a range from 80% to 95%. Assuming that the degree of generated light interference is not as high as affecting the light quality significantly, a member formed of a material including a silicone resin having a transmissivity of 100% may be employed as the first transparent member 20a.

The reflection ratio of the first transparent member 20a is a predetermined value, for example, 6.8%. The value of the reflection ratio of the first transparent member 20a is not limited thereto. For example, the reflection ratio of the first transparent member 20a may be any values in a range from 10% to 15%.

The sealing member 3a and the sealing member 5a may be formed of various resins such as epoxy resin, urea resin, and silicone resin. The sealing member 5a may be a transparent resin containing no fluorescent material and having a high diffusibility. Hereinafter, air to be encapsulated in the space defined by the main body 11 and the cover 13 is referred to as “sealed gas”. The sealed gas is, for example, atmospheric air.

In the light-emitting module 10a, an electrode 6a-1 described later is connected to an electrode bonding portion 14a-1. In the light-emitting module 10a, an electrode 8a-1 described later is connected to an electrode bonding portion 14b-1.

The main body 11 is formed of a metal having a good rate of thermal transfer, for example, aluminum. The main body 11 is formed into a column shape having a substantially circular lateral cross section, and the cover 13 is attached to one end and the cap member 12a is attached to the other end. The main body 11 is formed so as to form a substantially conical-shaped tapered surface having a diameter reducing gradually from one end to the other end. The main body 11 is formed to have a shape analogous to a silhouette of a neck portion of a miniature krypton bulb in appearance. The main body 11 includes a number of thermal radiation fins, not illustrated, each projecting radially from one end to the other end, formed integrally with an outer peripheral surface.

The cap member 12a is provided with, for example, a Edison type E-type cap, and includes a cylindrical shell formed of a copper plate and provided with a thread and an electrically conductive eyelet portion 112b provided on a crowning at a lower end of the shell via an electrically insulating portion. An opening of the shell is fixed to the opening of the main body 11 at the other end in a state of being electrically insulated. An input line, not shown, drawn from an electric input terminal of a circuit substrate, not shown of the control unit 14 is connected to the shell and the eyelet portion 12b.

The cover 13 constitutes a globe, and is formed of milky white polycarbonate and formed into a gentle curved surface shape analogous to the silhouette of the miniature krypton bulb having an opening at one end thereof. The cover 13 is fitted and fixed at an opening end thereof to the main body 11 so as to cover the light-emitting surface of the light-emitting module 10a. Accordingly, the lighting apparatus 100a is constituted as a capped lamp which is analogous to the silhouette of the miniature krypton bulb as the entire appearance shape and allows replacement with the miniature krypton bulb, with a glove which is the cover 13 at one end and with the cap member 12a of E-type at the other hand. A method of fixing the cover 13 to the main body 11 may be any suitable method such as bonding, fitting, screwing, or engaging.

The control unit 14 accommodates a control circuit, not illustrated, which controls lighting of the blue LEDs 4a and the red LEDs 2a mounted on the substrate 1 so as to be electrically insulated from the outside. The control unit 14 converts AC (Alternating Current) voltage to DC (Direct Current) voltage under control of the control circuit, and supplies the converted DC voltage to the blue LEDs 4a and the red LEDs 2a. The control unit 14 includes the electric wire 14a connected thereto for distributing electricity to the red LEDs 2a and the blue LEDs 4a to an output terminal of the control circuit thereof. The control unit 14 also includes second electric wire 14b connected to an input terminal of the control circuit thereof. The electric wire 14a and the electric wire 14b are covered so as to be insulated.

The electric wire 14a is drawn out to an opening of the main body 11 at one end via a through hole, not illustrated or a guide groove, not illustrated, formed on the main body 11. The electric wire 14a is joined at the electrode bonding portion 14a-1 which is a distal end portion having an insulating coating peeled off to the electrode 6a-1 of the wire arranged on the substrate 1. The electrode 6a-1 will be described later.

The electric wire 14b is drawn out to the opening of the main body 11 at one end via the through hole, not illustrated or a guide groove, not illustrated formed on the main body 11. The electric wire 14b is joined at the electrode bonding portion 14b-1 which is the distal end portion having the insulating coating peeled off to the electrode 8a-1 of the wire arranged on the substrate 1. The electrode 8a-1 will be described later.

In this manner, the control unit 14 supplies electricity input via the shell and the eyelet portion 12b to the blue LEDs 4a and the red LEDs 2a via the electric wires 14a. Then, the control unit 14 collects electricity supplied to the blue LEDs 4a and the red LEDs 2a via the electric wires 14b.

FIG. 2 illustrates a top view of the light-emitting module according to a first embodiment. FIG. 2 illustrates a top view of the light-emitting module 10a viewed from a direction indicated by an arrow A in FIG. 1. As illustrated in FIG. 2, the first LED group including a plurality of red LEDs 2a is arranged in such a manner that the LEDs are regularly disposed in a circular ring pattern on the circumference at the center of the substantially rectangular-shaped substrate 1. The first LED group including a plurality of red LEDs 2a is covered entirely in a ring shape with a sealing member 3a. In the substrate 1, an area covered with the sealing member 3a is referred to as a first area.

As illustrated in FIG. 2, the member 21a is arranged in a circular ring pattern on the outside of the circular ring-patterned first LED group. As illustrated in FIG. 2, the first transparent member 20a is arranged in a circular ring pattern on the inside of the circular ring-shaped first LED group.

As illustrated in FIG. 2, the second LED group including a plurality of blue LEDs 4a is arranged regularly in a reticular pattern near the center of the substantially rectangular-shaped substrate 1. The second LED group including the plurality of blue LEDs 4a is covered entirely with a sealing member 5a. The sealing member 5a covers the interior of the circular ring of the first area described above entirely. In the substrate 1, an area covered with the sealing member 5a is referred to as a second area.

As illustrates in FIG. 2, the shortest distance among the distances between the blue LEDs 4a and the red LEDs 2a is defined as a distance D1 between the blue LEDs 4a and the red LEDs 2a. The distance between the blue LEDs 4a and the red LEDs 2a is not limited to the shortest distance among the distances between the blue LEDs 4a and the red LEDs 2a, but may be a distance between a center position of the first LED group and a center position of the second LED group. In the example illustrated in FIG. 2, for example, the center position of the first LED group is a point on a circumference which passes respective centers of the red LEDs 2a arranged in a circular ring pattern. For example, a center position of the second LED group corresponds to a center of an area where the blue LEDs 4a are arranged in a reticular pattern. In this case, the distance between the blue LEDs 4a and the red LEDs 2a is a distance between the center of the area where the blue LEDs 4a are arranged in a reticular pattern and a point on the circumference passing through the respective centers of the red LEDs 2a arranged into a circular ring pattern.

The light-emitting module 10a inhibits, for example, effects of heat produced by the blue LEDs on the red LEDs even if a plurality of types of LEDs having heat characteristic significantly different from each other are consolidated separately by type of the LED on the substrate 1 formed of ceramics, for example, the effects of the heat produced by the blue LEDs received by the red LEDs are inhibited. Therefore, the light-emitting module 10a can easily have desired light-emitting properties.

The light-emitting module 10a may include, for example, the blue LEDs and the red LEDs in separate areas. Therefore, since the light-emitting module 10a inhibits, for example, the heat produced by the blue LEDs from being conducted to the red LEDs, the heat characteristic of the entire light-emitting module 10a is improved.

The first LED group is arranged so that the respective LEDs are arranged in a ring pattern on the substrate 1, and the second LED group is arranged at the center of the ring pattern on the substrate 1. In this manner, by arranging the LEDs in the first LED group which is susceptible to heat into a ring pattern which allows heat from being released more easily than the center of the ring pattern, lowering of the amount of luminescence of the first LED group inferior in thermal characteristic may be inhibited.

In FIG. 2, the numbers and the positions of the blue LEDs 4a and the red LEDs 2a are illustrative only. In other words, any configuration is applicable as long as the blue LEDs 4a are arranged regularly near the center of the substrate 1, and the red LEDs 2a are arranged regularly so as to surround the blue LEDs 4a.

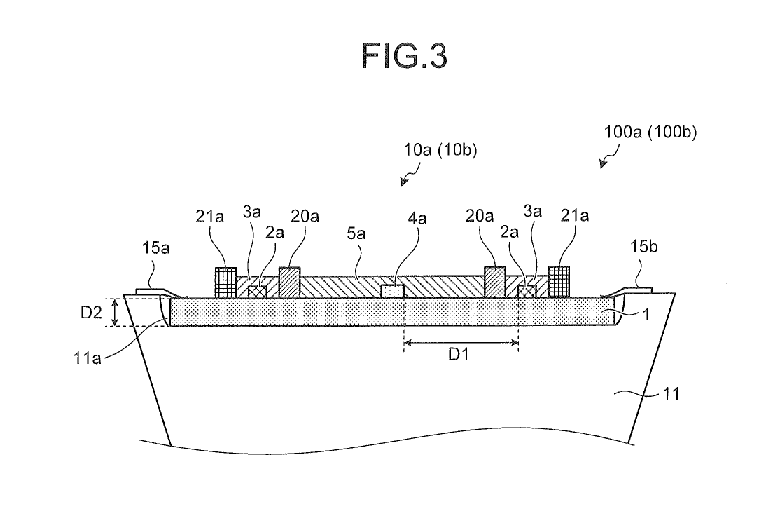

FIG. 3 illustrates a lateral cross-sectional view of a lighting apparatus having a light-emitting module according to a first embodiment mounted thereon. FIG. 3 illustrates a cross-sectional view of the light-emitting module 10a taken along the line B-B in FIG. 2. In FIG. 3, illustration of the cover 13 of the lighting apparatus 100a and the lower portion of the main body 11 is omitted. As illustrated in FIG. 3, the main body 11 of the lighting apparatus 100a includes a depression 11a where the substrate 1 of the light-emitting module 10a is accommodated, and a fixing member 15a and a fixing member 15b for fixing the substrate 1. The light-emitting module 10a includes the substrate 1 being accommodated in the depression 11a of the main body 11.

The light-emitting module 10a is fixed to the main body 11 by an edge portion of the substrate 1 pressed downward of the depression 11a by pressing forces of the fixing member 15a and the fixing member 15b. Accordingly, the light-emitting module 10a is mounted on the lighting apparatus 100a. A method of mounting the light-emitting module 10a to the lighting apparatus 100a is not limited to the method illustrated in FIG. 3, and any suitable method such as adhering, fitting, screwing, and engaging may be employed.

As illustrated in FIG. 3, the distance D1 between the blue LED 4a and the red LED 2a is longer than a thickness D2 of the substrate 1 in the perpendicular direction. The heat produced by light emission of the blue LEDs 4a and the red LEDs 2a are liable to be transferred in the horizontal direction than in the perpendicular direction. Therefore, for example, the heat produced by the blue LEDs 4a is transferred to the red LED 2a via the horizontal direction of the substrate 1, and the light-emitting efficiency of the red LEDs 2a is further worsened. However, by setting the distance D1 between the blue LEDs 4a and the red LEDs 2a to be longer than the thickness D2 of the substrate 1 in the perpendicular direction, the heat produced by the blue LEDs 4a is inhibited from being transferred to the red LEDs 2a via the horizontal direction of the substrate 1. Therefore, worsening of the light-emitting efficiency of the red LEDs 2a is inhibited.

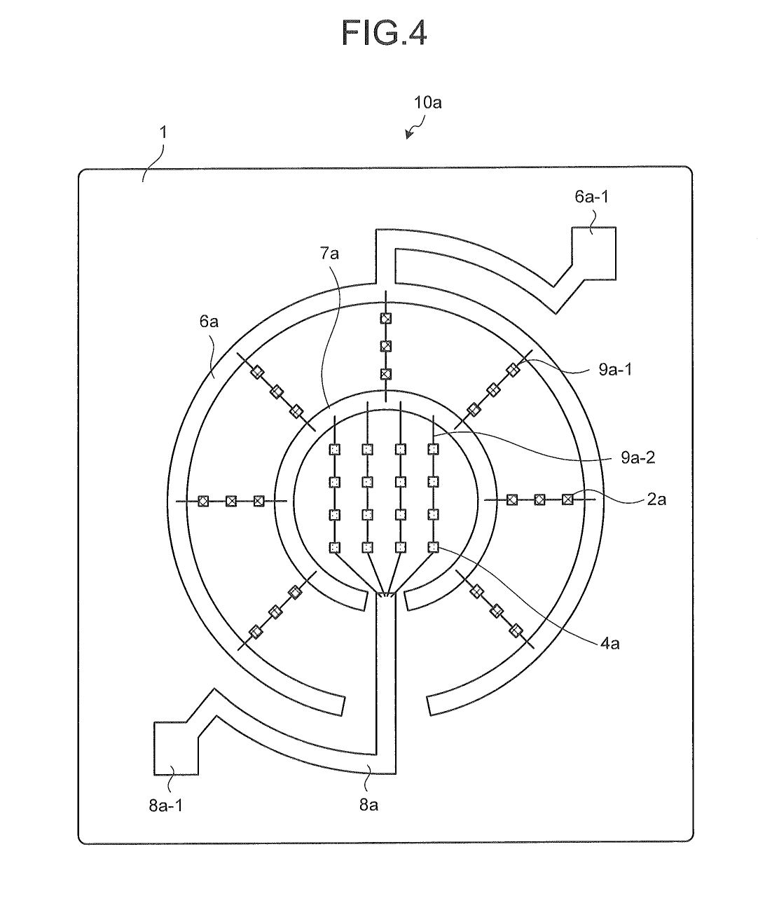

FIG. 4 illustrates electric wire of the light-emitting module according to the first embodiment. As illustrated in FIG. 4, the light-emitting module 10a includes an electrode 6a-1 to be connected to the electrode bonding portion 14a-1 of the lighting apparatus 100a on the substrate 1 and a wire 6a extending from the electrode 6a-1 on the substrate 1. The light-emitting module 10a includes wires 7a to be connected in parallel with the wire 6a via the plurality of the red LEDs 2a connected in series by the bonding wire 9a-1. The light-emitting module 10a includes wires 8a to be connected in parallel with the wire 7a via the plurality of the blue LEDs 4a connected in series by the bonding wire 9a-2. The wire 8a includes an electrode 8a-1 to be connected to the electrode bonding portion 14b-1 of the lighting apparatus 100a at a distal end of extension.

In this manner, by connecting a plurality of the red LED 2a and a plurality of the blue LED 4a connected in series by the bonding wire 9a-1 and the bonding wire 9a-2 in parallel, the amount of the current flowing in the areas where the respective blue LEDs 4a and the respective red LEDs 2a exist is reduced to inhibit heat generation. Therefore, the light-emitting module 10a reduces worsening of the light-emitting properties due to the heat generation. Furthermore for example, the number of the parallel connections of the blue LEDs 4a connected in series by the bonding wire 9a-2 is increased to be larger than that illustrated in FIG. 4, so that an electric current flowing through one blue LED 4a is set to be smaller than an electric current flowing through one red LED 2a. Accordingly, the light-emitting module 10a alleviates worsening of the light-emitting property due to the worsening of the light-emitting property of the red LEDs 2a due to the heat.

As described above, the light emitted from the red LEDs 2a and the light emitted from the blue LEDs 4a transmit through the first transparent member 20a. Accordingly, a range irradiated by the light emitted from the red LEDs 2a and the light emitted from the blue LEDs 4a is widened, and the light emitted from the light-emitting module 10a is inhibited in the angle-to-angle brightness difference and the angular color difference.

In the first embodiment described above, the red LEDs 2a are arranged in a circular ring pattern on the substrate 1, and the blue LEDs 4a are arranged near the center of the circular ring. However, the pattern of arrangement is not limited to the circular ring pattern, and any suitable pattern such as a rectangular pattern or a diamond pattern as long as it is a shape arranged in a ring pattern.

The light-emitting module 10a according to the first embodiment includes the substrate 1. The light-emitting module 10a according to the first embodiment includes the light-emitting elements (for example, the red LED 2a and the blue LED 4a) of different types provided on the substrate 1, the light-emitting elements of each such type configured to emit light having a different wavelength. The light-emitting module 10a according to the first embodiment includes the first transparent member 20a configured to allow light emitted from the light-emitting elements to be transmitted at a predetermined transmissivity and partition the light-emitting element on the substrate 1 according to their type. Also, according to the light-emitting modules 10a of the first embodiment, light emitted from the light-emitting elements is transmitted through the first transparent member 20a at a predetermined transmissivity in a state in which the light-emitting elements are partitioned by type. Accordingly, a range irradiated with the light emitted from the light emitting elements of different types is widened. Therefore, the angle-to-angle brightness difference and the angular color difference of the light output from the light-emitting module 10a according to the first embodiment are inhibited. Therefore, according to the light-emitting module 10a of the first embodiment, output of relatively homogeneous and good quality light is achieved.

In the first embodiment, the light-emitting elements (for example, the blue LEDs 4a) of the first type have a first thermal characteristic such that luminescence of the light-emitting element of the first type is lowered with an increase in temperature of the light-emitting element of the first type. The light-emitting elements (the red LEDs 2a) of the second type have a second thermal characteristic such that the luminescence of the light-emitting elements of second type is lowered with an increase in temperature of the light-emitting element of the second type by a larger amount than the luminescence of the light-emitting elements of the first type is lowered.

In the first embodiment, the light-emitting elements of the second type are arranged, for example, in a ring pattern on the substrate 1, and the light-emitting elements of the first type are arranged at the center of the ring pattern on the substrate 1. In this manner, by arranging the second type light-emitting elements which are susceptible to heat into a ring pattern which allows heat from being released easily by the center of the ring pattern, lowering of the amount of luminescence of the second type light-emitting element inferior in thermal characteristic may be inhibited.

The lighting apparatus 100a according to the first embodiment includes a light-emitting module 10a. According to lighting apparatus 100a of first embodiment, light emitted from the light-emitting elements is transmitted through the first transparent member 20a at a predetermined transmissivity in a state in which the light-emitting elements are partitioned by type. Accordingly, the range irradiated with the light emitted from the light emitting elements is widened. Therefore, the angle-to-angle brightness different and the angular color difference of the light output from the lighting apparatus 100a according to the first embodiment are inhibited. Therefore, according to the lighting apparatus 100a of the first embodiment, output of relatively homogeneous and good quality light is achieved.

### Second Embodiment

Subsequently, a second embodiment will be described. The second embodiment is different from the first embodiment in that a second transparent member 21b is employed instead of the member 21a. Other points are the same as the first embodiment, and hence the description will be omitted.

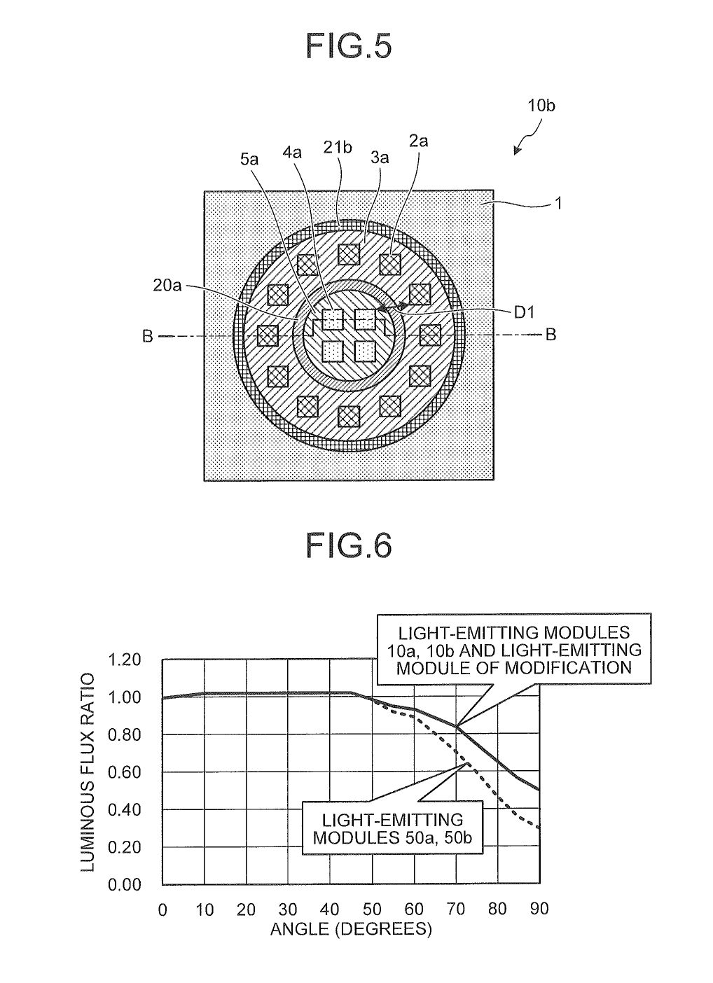

FIG. 5 illustrates a top view of the light-emitting module according to a second embodiment. FIG. 5 illustrates a top view of the light-emitting module 10b viewed from a direction indicated by an arrow A in FIG. 1. As illustrated in FIG. 5, the first LED group including a plurality of red LEDs 2a is arranged in such a manner that the LEDs are regularly disposed in a circular ring pattern on the circumference of the center of the substantially rectangular-shaped substrate 1. The first LED group including a plurality of red LEDs 2a is covered entirely in a ring shape with a sealing member 3a.

As illustrated in FIG. 5, the second transparent member 21b is arranged in a circular ring pattern on the outside of the circular ring-patterned first LED group. As illustrated in FIG. 5, the first transparent member 20a is arranged in a circular ring pattern on the inside of the circular ring-patterned first LED group.

The second transparent member 21b is provided on the outside of a plurality of types of the light-emitting elements (the red LEDs 2a and the blue LEDs 4a), and the light emitted from the light-emitting elements is transmitted at a predetermined transmissivity. The second transparent member 21b is formed of a material including silicone resin. The second transparent member 21b allows light emitted from the blue LEDs 4a and the red LEDs 2a at a predetermined transmissivity. The transmissivity of the second transparent member 21b is, for example, 86%. The value of the transmittance of the second transparent member 21b is not limited thereto. For example, the transmissivity of the second transparent member 21b may by any values in a range from 80% to 95%.

The reflection ratio of the second transparent member 21b is a predetermined value, for example, 6.8%. The value of the reflection ratio of the second transparent member 21b is not limited thereto. For example, the reflection ratio of the second transparent member 21b may be any values in a range from 10% to 15%.

As described above, the light emitted from the red LEDs 2a and the light emitted from the blue LEDs 4a transmit through the first transparent member 20a. Accordingly, a range irradiated by the light emitted from the red LEDs 2a and the light emitted from the blue LEDs 4a is widened, and hence the angle-to-angle brightness and the angular color difference of the light emitted from the light-emitting module 10b are inhibited.

The light emitted from the red LEDs 2a and the light emitted from the blue LEDs 4a transmits through the second transparent member 21b. Accordingly, the range irradiated with the light emitted from the light emitting elements is widened. Therefore, color separation and an angular color difference of the light output from the light-emitting module 10b of the second embodiment are inhibited. Therefore, according to the light-emitting module 10b of the second embodiment, output of relatively homogeneous and good quality light is achieved.

The second embodiment has been described thus far. The light-emitting module 10b according to the second embodiment includes the substrate 1. The light-emitting module 10b according to the second embodiment includes the light-emitting elements (for example, the red LED 2a and the blue LED 4a) of different types provided on the substrate 1, the light-emitting elements of each such type configured to emit light having a different wavelength. The light-emitting module 10b according to the second embodiment includes the first transparent member 20a configured to allow light emitted from the light-emitting elements to be transmitted at a predetermined transmissivity and partition the light-emitting elements on the substrate 1 according to their type. According to light-emitting modules 10b of the second embodiment, light emitted from the light-emitting elements is transmitted through the first transparent member 20a at a predetermined transmissivity in a state in which the light-emitting elements are partitioned by type. Accordingly, a range irradiated with the light emitted from the light emitting elements of different types is widened. Therefore, the angle-to-angle brightness different and the angular color difference of the light output from the light-emitting module 10b according to the second embodiment are inhibited. Therefore, according to the light-emitting module 10b of the second embodiment, output of relatively homogeneous and good quality light is achieved.

In the second embodiment, the light-emitting elements (for example, the blue LEDs 4a) of the first type have a first thermal characteristic such that luminescence of the light-emitting element of the first type is lowered with an increase in temperature of the light-emitting element of the first type. The light-emitting elements (the red LEDs 2a) of the second type have a second thermal characteristic such that the luminescence of the light-emitting elements of second type is lowered with an increase in temperature of the light-emitting element of the second type by a larger amount than the luminescence of the light-emitting elements of the first type is lowered.

In the second embodiment, the light-emitting elements of the second type are arranged, for example, in a ring pattern on the substrate 1, and the light-emitting elements of the first type are arranged at the center of the ring pattern on the substrate 1. In this manner, by arranging the second type light-emitting elements which are susceptible to heat into a ring pattern which allows heat from being released more easily than the center of the annular pattern, lowering of the amount of luminescence of the second type light-emitting element inferior in thermal characteristic may be inhibited.

The lighting apparatus 100b according to the second embodiment includes a light-emitting module 10b. According to lighting apparatus 100b of the second embodiment, light emitted from the light-emitting elements is transmitted through the first transparent member 20a at a predetermined transmissivity in a state in which the light-emitting elements are partitioned by type. Accordingly, the range irradiated with the light emitted from the light emitting elements is widened. Therefore, the angle-to-angle brightness different and the angular color difference of the light output from the lighting apparatus 100b according to the second embodiment are inhibited. Therefore, according to the lighting apparatus 100b of the second embodiment, output of relatively homogeneous and good quality light is achieved.

In the second embodiment, the light emitted from the red LEDs 2a and the light emitted from the blue LEDs 4a transmit through the second transparent member 21b. Accordingly, the range irradiated with the light emitted from the light emitting elements is widened. Therefore, color separation and an angular color difference of the light output from the light-emitting module 10b of the second embodiment are inhibited. Therefore, according to the light-emitting module 10b of the second embodiment, output of relatively homogeneous and good quality light is achieved.

The respective embodiments has been described thus far. In the above-described embodiment, a case where the red LEDs 2a and the blue LEDs 4a are sealed by the sealing portion 3a and the sealing portion 5a, respectively has been described. However, the light-emitting module is not limited to this example. For example, the red LEDs 2a and the blue LEDs 4a of the light-emitting module may be sealed by the same sealing portion 3a. In this case, the second transparent member 21b may be used without using the first transparent member 20a in the light-emitting module. Hereinafter, the light-emitting module as described above is referred to as a light-emitting module of a modification.

Here, the result of experiment in which light characteristics of the light-emitting module 10a of the first embodiment, the light emitting module 10b of the second embodiment, and the light-emitting module of the modification, and light emitting modules 50a, 50b of the comparative example are compared will be described by using Table 1 given below. Here, the light-emitting module 50a is a modification of the light-emitting module 10a in which a white member is used instead of the first transparent member 20a. The light-emitting module 50b is a modification of the light-emitting module in which a member 21a is used instead of the second transparent member 21b.

TABLE 1

| | | | light- | | |
|---|---|---|---|---|---|
| | light- | light- | emitting | light- | light- |
| | emitting | emitting | module of | emitting | emitting |
| | module 10a | module 10b | modification | module 50a | module 50b |
| color | B | B | B | D | D |
| separation | | | | | |
| light | B | B | B | A | C |
| interference | | | | | |
| extracting | A | A | A | A | C |
| efficiency | | | | | |

As shown in Table 1, evaluation items of objects of experiment include how much the “color separation” could be reduced, how much the “light interference” could be reduced, and the light “extraction efficiency” of the red LEDs 4a. Table 1 shows a case in which these evaluation items are evaluated on the basis of four levels of “well down (A)”, “done (B)”, “reasonably done (C)”, and “not well down (D)”. It is understood from Table 1 that evaluations of both of the light-emitting modules 10a, 10b are not low and hence the light-emitting modules 10a, 10b are practical. It is also understood that the evaluation of the light-emitting module of the modification is not low, and hence the light-emitting module of the modification is practical.

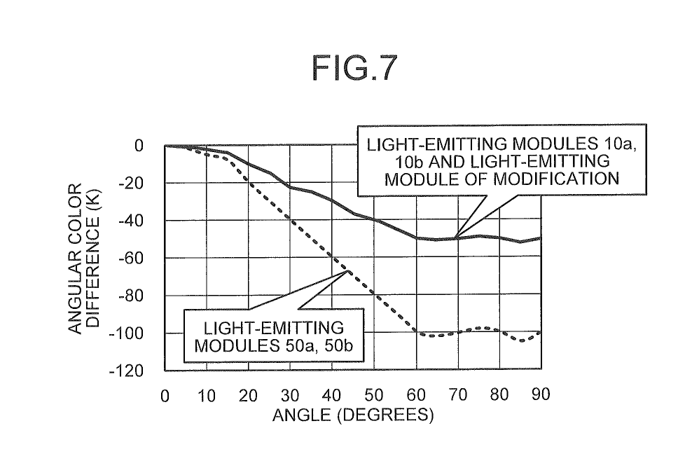

FIG. 6 and FIG. 7 illustrate an example of the result of experiment. FIG. 6 is an angle-to-angle graph indicating a luminous flux ratio. It is understood from FIG. 6 that when an angle becomes large, the light-emitting modules 10a, 10b and the light-emitting module of the modification can maintain the luminous flux ratio more than the light-emitting modules 50a, 50b. It is understood from FIG. 7 that the light-emitting modules 10a, 10b and the light-emitting module of the modification inhibit the color difference more than the light-emitting modules 50a, 50b.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light-emitting module comprising:
a substrate;
light-emitting elements of different types provided on the substrate, the light-emitting elements of each such type configured to emit light having a different wavelength; and
a first transparent member provided on the substrate and configured to partition the light-emitting elements on the substrate according to their type and allow light emitted from the light-emitting elements to be transmitted at a predetermined transmissivity.

2. The light-emitting module according to claim 1, wherein the transmissivity of the first transparent member falls within a range from 80% to 95% inclusive.

3. The light-emitting module according to claim 1, wherein the transmissivity of the first transparent member is 100%.

4. The light-emitting module according to claim 1, wherein the reflection ratio of the first transparent member falls within a range from 10% to 15% inclusive.

5. The light-emitting module according to claim 1, wherein the first transparent member is formed of a material including a silicone resin.

6. The light-emitting module according to claim 1, further comprising: a second transparent member provided an outer periphery of the light-emitting elements of different types and configured to allow light emitted from the light-emitting elements at a predetermined transmissivity.

7. The light-emitting module according to claim 6, wherein the transmittance of the second transparent member falls within a range from 80% to 95% inclusive.

8. The light-emitting module according to claim 6, wherein the reflection ratio of the second transparent member falls within a range from 10% to 15% inclusive.

9. The light-emitting module according to claim 6, wherein the second transparent member is formed of the material including the silicone resin.

10. The light-emitting module according to claim 1, wherein the plurality of the light-emitting elements include light-emitting elements of a first type configured to emit light having a first wavelength and light-emitting elements of a second type configured to emit light having a second wavelength.

11. The light-emitting module according to claim 3, wherein the light-emitting elements of the first type have a first thermal characteristic such that luminescence of the light-emitting elements of the first type is lowered with an increase in temperature of the light-emitting elements of the first type, and
the light-emitting elements of the second type have a second heat characteristic such that luminescence of the light-emitting elements of the second type is lowered with an increase in temperature of the light-emitting element of the second type by a larger amount than the luminescence of the light-emitting elements of the first type is lowered.

12. The light-emitting module according to claim 11, wherein the light-emitting elements of the second type are arranged in a ring pattern on the substrate, and
the light-emitting elements of the first type are arranged at a center of the ring pattern on the substrate.

13. The light-emitting module according to claim 12, wherein the ring pattern includes a circular ring pattern, a rectangular pattern, and a diamond pattern.

14. The light-emitting module according to claim 3, wherein a minimum distance between the light-emitting elements of the first type and the light-emitting elements of the second type is longer than a length of the substrate in a direction that is perpendicular to the surface of the substrate.

15. A lighting apparatus comprising a light-emitting module including:
light-emitting elements of different types provided on the substrate, the light-emitting elements of each such type configured to emit light having a different wavelength; and
a first transparent member provided on the substrate and configured to partition the light-emitting elements on the substrate according to their type and allow light emitted from the light-emitting elements to be transmitted at a predetermined transmissivity.

16. A light-emitting module comprising:
a substrate;
light-emitting elements of a first type mounted on the substrate, the light-emitting elements of the first type configured to emit light having a first wavelength;
light-emitting elements of a second type mounted on the substrate, the light-emitting elements of the second type configured to emit light having a second wavelength;
a transparent member disposed on the substrate to partition the light-emitting elements of the first type from the light-emitting elements of the second type on the substrate,
wherein the transparent member has a height dimension measured from the surface of the substrate that is greater than a height dimension of the light-emitting elements of the first and second types measured from the surface of the substrate.

17. The light-emitting module according to claim 16, wherein the transparent member has a light transmissivity of 80% to 95%.

18. The light-emitting module according to claim 16, wherein the transparent member has a light transmissivity of 100%.

19. The light-emitting module according to claim 16, wherein the transparent member has a reflection ratio of 10% to 15%.

20. The light-emitting module according to claim 16, further comprising:
an additional transparent member disposed on the substrate on the outer periphery of the light-emitting elements of the first and second types,
wherein the additional transparent member has a height dimension measured from the surface of the substrate that is greater than a height dimension of the light-emitting elements of the first and second types measured from the surface of the substrate.
